(19) United States
(12) Patent Application Publication
(10) Pub. No.: US 2018/0016806 A1
(43) Pub. Date: Jan. 18, 2018

(54) Animatronic Agitating Assembly

(71) Applicant: Anissa Bullard, North Richland Heights, TX (US)

(72) Inventor: Anissa Bullard, North Richland Heights, TX (US)

(21) Appl. No.: 15/210,369

(22) Filed: Jul. 14, 2016

(51) Int. Cl. E04H 4/12; B01F 11/04; B01F 11/00; B01F 15/00

(52) U.S. Cl. CPC E04H 4/12; B01F 15/00441; B01F 11/04; B01F 11/0097; B01F 2015/0011; B01F 2015/00649

(57) ABSTRACT

An animatronic agitating assembly includes an animatron that may be positioned on an edge of a pool. The animatron has a head, a torso, a pair of arms and a pair of legs. A motion unit is coupled to the animatron. The motion unit urges each of the legs to move back and forth with respect to the torso. Thus, each of the legs may agitate water in the pool.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98

The disclosure and prior art relates to agitating devices and more particularly pertains to a new agitating device for agitating water in a pool.

### BRIEF SUMMARY OF THE INVENTION

An embodiment of the disclosure meets the needs presented above by generally comprising an animatron that may be positioned on an edge of a pool. The animatron has a head, a torso, a pair of arms and a pair of legs. A motion unit is coupled to the animatron. The motion unit urges each of the legs to move back and forth with respect to the torso. Thus, each of the legs may agitate water in the pool.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective in-use view of an animatronic agitating assembly according to an embodiment of the disclosure.

FIG. 2 is a back view of an embodiment of the disclosure.

FIG. 3 is a front phantom view of an embodiment of the disclosure.

FIG. 4 is a left side cut-away view of an embodiment of the disclosure.

### DETAILED DESCRIPTION OF THE INVENTION

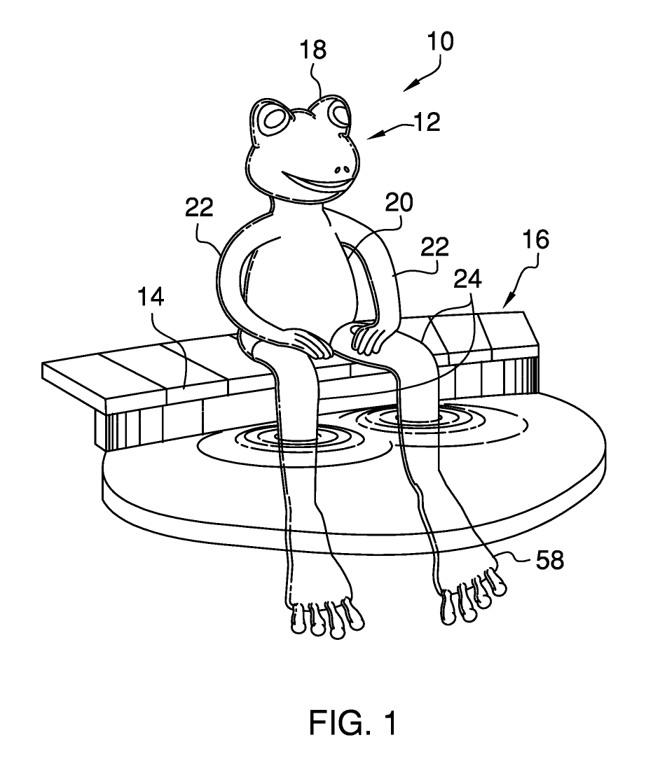

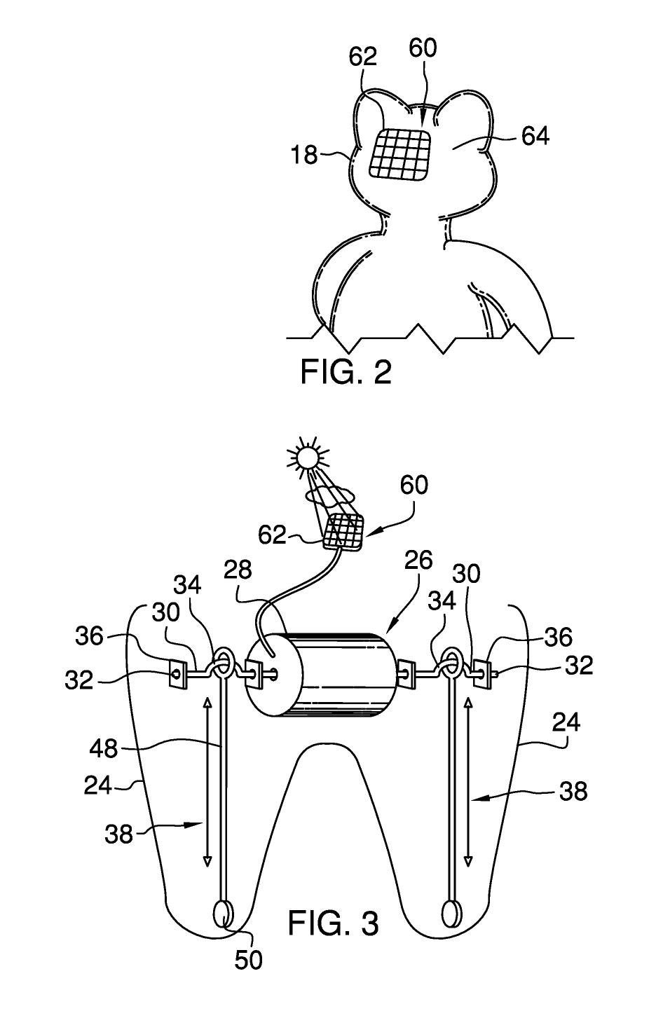

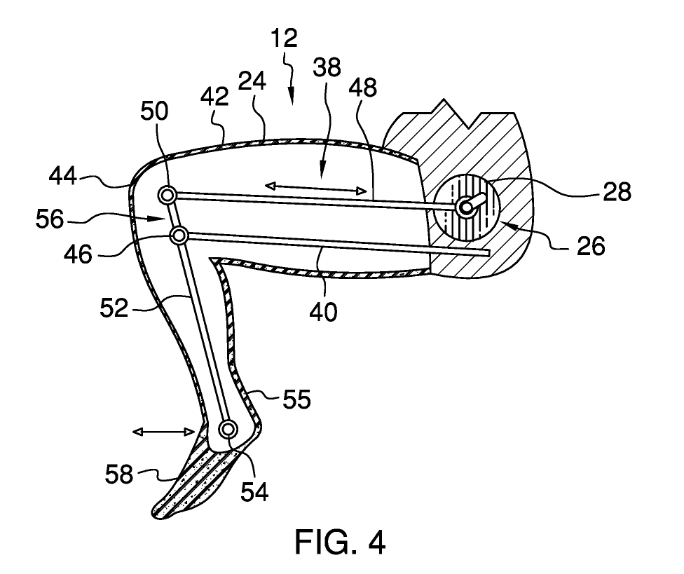

With reference now to the drawings, and in particular to FIGS. 1 through 4 thereof, a new agitating device embodying the principles and concepts of an embodiment of the disclosure and generally designated by the reference numeral 10 will be described.

As best illustrated in FIGS. 1 through 4, the animatronic agitating assembly 10 generally comprises an animatron 12. The animatron 12 may be positioned on an edge 14 of a pool 16. The pool 16 may be a swimming pool 16 or the like. The animatron 12 has a head 18, a torso 20, a pair of arms 22 and a pair of legs 24.

Each of the head 18, the torso 20 and the pair of arms 22 may be comprised of a rigid material. Each of the legs 24 may be comprised of a flexible material. Each of the legs 24 may extend into water 25 in the pool 16. The animatron 12 may be structured to resemble, but not being limited to, any animal, a human likeness, fictional and mythological characters.

A motion unit 26 is provided. The motion unit 26 is coupled to the animatron 12.

The motion unit 26 urges each of the legs 24 to move back and forth with respect to the torso 20. Thus, each of the legs 24 may agitate the water 25 in the pool 16.

The motion unit 26 comprises a motor 28 that is positioned within the torso 20. The motor 28 is horizontally oriented in the torso 20. The motor 28 may be an electric motor 28 or the like. Additionally, the motor 28 is aligned with each of the legs 24.

A pair of drive shafts 30 is provided. Each of the drive shafts 30 is rotatably coupled to the motor 28. Thus, the motor 28 rotates each of the drive shafts 30 when the motor 28 is turned on. Each of the drive shafts 30 is positioned on opposite ends of the motor 28. Each of the drive shafts 30 is horizontally oriented in the torso 20.

Each of the drive shafts 30 has a distal end 32 with respect to the motor 28 and a central portion 34. The central portion 34 corresponding to each of the drive shafts 30 is concavely arcuate. Thus, the central portion 34 corresponding to each of the drive shafts 30 orbits about a longitudinal axis of the corresponding drive shaft 30 when the motor 28 is turned on.

A pair of bearings 36 is provided. Each of the bearings 36 is positioned in the torso 20. Each of the bearings 36 insertably receives the distal end of an associated one of the drives shafts. Each of the bearings 36 retains the associated drive shaft 30 in the horizontal orientation.

A pair of linkages 38 is provided. Each of the linkages 38 is positioned in an associated one of the legs 24. Each of the linkages 38 is coupled to an associated one of the drive shafts 30. Thus, each of the linkages 38 urges the associated leg 24 to move back and forth when the motor 28 is turned on.

Each of the linkages 38 comprises a first shaft 40 that is immovably positioned within a thigh 42 of the associated leg 24. The first shaft 40 extends between the motor 28 and a knee 44 of the associated leg 24. The first shaft 40 is horizontally oriented in the associated leg 24. The first shaft 40 has a distal end 46 with respect to the motor 28. The distal end corresponding to the first shaft 40 is positioned in the knee 44 of the associated leg 24.

A second shaft 48 is provided. The second shaft 48 is movably positioned within the thigh 42 of the associated leg 24. The second shaft 48 is horizontally oriented in the associated leg 24. The second shaft 48 is spaced from and is coextensive with the first shaft 40.

The second shaft 48 is coupled to the central portion 34 of the associated drive shaft 30. Thus, the associated drive shaft 30 alternatively urges the second shaft 48 to travel forwardly and rearwardly in the associated leg 24 when the motor 28 is turned on. The second shaft 48 has a distal end 50 with respect to the motor 28. The distal end 50 corresponding to the second shaft 48 is positioned in the knee 44 of the associated leg 24.

A third shaft 52 is positioned within a shin of the associated leg 24 and the third shaft 52 is vertically oriented in the associated leg 24. The third shaft 52 is movably coupled to the distal end 46,50 corresponding to each of the first shaft 40 and the second shaft 48. The third shaft 52 has a bottom end 54 and the bottom end 54 is positioned in an ankle 55 of the associated leg 24.

The distal end 46 corresponding to the first shaft 40 defines a fulcrum 56 of the third shaft 52. The second shaft 48 urges the third shaft 52 to rock on the fulcrum 56 when the motor 28 is turned on. The third shaft 52 alternatively urges a foot 58 on the associated leg 24 to move back and forth. Thus, the foot 58 on the associated leg 24 may agitate the water 25 in the pool 16.

A power supply 60 is provided. The power supply 60 is coupled to the head 18. The power supply 60 is electrically coupled to the motor 28. The power supply 60 comprises a solar cell 62. The solar cell 62 is positioned on a rear side 64 of the head 18. Thus, the solar cell 62 may be exposed to sunlight thereby facilitating the solar cell 62 to convert solar energy into electrical energy.

In use, the animatron 12 is positioned on the edge 14 of the pool 16 such that each of the legs 24 extends downwardly into the water 25 in the pool 16. The solar cell 62 converts sunlight into electrical energy to power the motor 28. Thus, the motor 28 rotates each of the drive shafts 30. Each of the linkages 38 urges the foot 58 corresponding to the associated leg 24 to move back and forth in the water 25. Thus, the associated leg 24 agitates the water 25 in the pool 16.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An animatronic agitating assembly being configured to be positioned on the edge of a pool thereby facilitating said assembly to agitate water in the pool, said assembly comprising:
an animatron being configured to be positioned on an edge of a pool, said animatron having a head, a torso, a pair of arms and a pair of legs; and
a motion unit being coupled to said animatron, said motion unit urging each of said legs to move back and forth with respect to said torso wherein each of said legs is configured to agitate the water in the pool.

2. The assembly according to claim 1, wherein each of said head, said torso and said pair of arms being comprised of a rigid material, each of said legs being comprised of a flexible material, each of said legs being configured to extend into water in the pool.

3. The assembly according to claim 1, wherein said motion unit comprises a motor being positioned within said torso, said motor being horizontally oriented in said torso.

4. The assembly according to claim 3, further comprising a pair of drive shafts, each of said drive shafts being rotatably coupled to said motor such that motor rotates each of said drive shafts when said motor is turned on, each of said drive shafts being positioned on opposite ends of said motor, each of said drive shafts being horizontally oriented in said torso, each of said drive shafts having a distal end with respect to said motor and a central portion.

5. The assembly according to claim 4, wherein said central portion corresponding to each of said drive shafts being concavely arcuate such that said central portion corresponding to each of said drive shafts orbits about an longitudinal axis of said corresponding drive shaft when said motor is turned on.

6. The assembly according to claim 4, further comprising a pair of bearings, each of said bearings being positioned in said torso, each of said bearings insertably receiving said distal end of an associated one of said drives shafts.

7. The assembly according to claim 4, further comprising a pair of linkages, each of said linkages being positioned in an associated one of said legs, each of said linkages being coupled to an associated one of said drive shafts such that each of said linkages urges said associated leg to move back and forth when said motor is turned on.

8. The assembly according to claim 7, wherein each of said linkages comprises a first shaft being immovably positioned within a thigh of said associated leg, said first shaft extending between said motor and a knee of said associated leg, said first shaft being horizontally oriented in said associated leg, said first shaft having a distal end with respect to said motor, said distal end being positioned in said knee of said associated leg.

9. The assembly according to claim 8, further comprising a second shaft being movably positioned within said thigh of said associated leg, said second shaft being horizontally oriented in said associated leg, said second shaft being spaced from and being coextensive with said first shaft, said second shaft being coupled to a central portion of said associated drive shaft such that said associated drive shaft alternatively urges said second shaft to travel forwardly and rearwardly in said associated leg when said motor is turned on, said second shaft having a distal end with respect to said motor, said distal end corresponding to said second shaft being positioned in said knee of said associated leg.

10. The assembly according to claim 9, further comprising a third shaft being positioned within a shin of said associated leg, said third shaft being vertically oriented in said associated leg, said third shaft being movably coupled to said distal end corresponding to each of said first shaft and said second shaft, said third shaft having a bottom end, said bottom end being positioned in an ankle of said associated leg.

11. The assembly according to claim 10, wherein said distal end corresponding to said first shaft defines a fulcrum of said third shaft, said second shaft urging said third shaft to rock on said fulcrum when said motor is turned on such that said third shaft alternatively urges a foot on said associated leg to move back and forth wherein said foot on said associated leg is configured to agitate the water in the pool.

12. The assembly according to claim 3, further comprising a power supply being coupled to said head, said power supply being electrically coupled to said motor, said power supply comprising a solar cell, said solar cell being positioned on an rear side of said head wherein said solar cell is configured to be exposed to sunlight thereby facilitating said solar cell to convert solar energy into electrical energy.

13. An animatronic agitating assembly being configured to be positioned on the edge of a pool thereby facilitating said assembly to agitate water in the pool, said assembly comprising:
an animatron being configured to be positioned on an edge of a pool, said animatron having a head, a torso, a pair of arms and a pair of legs, each of said head, said torso and said pair of arms being comprised of a rigid material, each of said legs being comprised of a flexible material, each of said legs being configured to extend into water in the pool; and
a motion unit being coupled to said animatron, said motion unit urging each of said legs to move back and forth with respect to said torso wherein each of said legs is configured to agitate the water in the pool, said motion unit comprising:
a motor being positioned within said torso, said motor being horizontally oriented in said torso,
a pair of drive shafts, each of said drive shafts being rotatably coupled to said motor such that motor rotates each of said drive shafts when said motor is turned on, each of said drive shafts being positioned on opposite ends of said motor, each of said drive shafts being horizontally oriented in said torso, each of said drive shafts having a distal end with respect to said motor and a central portion, said central portion corresponding to each of said drive shafts being concavely arcuate such that said central portion corresponding to each of said drive shafts orbits about an longitudinal axis of said corresponding drive shaft when said motor is turned on,
a pair of bearings, each of said bearings being positioned in said torso, each of said bearings insertably receiving said distal end of an associated one of said drives shafts,
a pair of linkages, each of said linkages being positioned in an associated one of said legs, each of said linkages being coupled to an associated one of said drive shafts such that each of said linkages urges said associated leg to move back and forth when said motor is turned on, each of said linkages comprising:
a first shaft being immovably positioned within a thigh of said associated leg, said first shaft extending between said motor and a knee of said associated leg, said first shaft being horizontally oriented in said associated leg, said first shaft having a distal end with respect to said motor, said distal end being positioned in said knee of said associated leg,
a second shaft being movably positioned within said thigh of said associated leg, said second shaft being horizontally oriented in said associated leg, said second shaft being spaced from and being coextensive with said first shaft, said second shaft being coupled to said central portion of said associated drive shaft such that said associated drive shaft alternatively urges said second shaft to travel forwardly and rearwardly in said associated leg when said motor is turned on, said second shaft having a distal end with respect to said motor, said distal end corresponding to said second shaft being positioned in said knee of said associated leg, and
a third shaft being positioned within a shin of said associated leg, said third shaft being vertically oriented in said associated leg, said third shaft being movably coupled to said distal end corresponding to each of said first shaft and said second shaft, said third shaft having a bottom end, said bottom end being positioned in an ankle of said associated leg, said distal end corresponding to said first shaft defining a fulcrum of said third shaft, said second shaft urging said third shaft to rock on said fulcrum when said motor is turned on such that said third shaft alternatively urges a foot on said associated leg to move back and forth wherein said foot on said associated leg is configured to agitate the water in the pool; and
a power supply being coupled to said head, said power supply being electrically coupled to said motor, said power supply comprising a solar cell, said solar cell being positioned on an rear side of said head wherein said solar cell is configured to be exposed to sunlight thereby facilitating said solar cell to convert solar energy into electrical energy.
